(19) United States
(12) Patent Application Publication
(10) Pub. No.: US 2025/0328215 A1
(43) Pub. Date: Oct. 23, 2025

(54) DISPLAY CONTROL METHOD AND DEVICE FOR VIRTUAL OBJECT, STORAGE MEDIUM, AND ELECTRONIC DEVICE

(71) Applicant: NETEASE (HANGZHOU) NETWORK CO., LTD., Hangzhou (CN)

(72) Inventor: Zhenyue LIU, Hangzhou (CN)

(21) Appl. No.: 18/872,102

(22) PCT Filed: Mar. 3, 2023
(86) PCT No.: PCT/CN2023/079641

§ 371 Date: Dec. 5, 2024

(30) Foreign Application Priority Data
Jun. 8, 2022 (CN) 202210641066.3

(51) Int. Cl. G06F 3/04815; G06F 3/0486

(52) U.S. Cl. CPC G06F 3/04815; G06F 3/0486

(57) ABSTRACT

The present disclosure provides a display control method for a virtual object. The method includes: displaying, in a graphical user interface provided by a terminal device, a first virtual scene picture corresponding to a first scale; displaying, in the graphical user interface, a target virtual scene picture corresponding to a target scale and an object control in response to a first operation of switching the first scale to the target scale; and controlling, in response to a second operation on the object control, a virtual controlled object corresponding to the object control to move from a first virtual model to which the virtual controlled object belongs, to a second virtual model in the virtual model set.

### CROSS REFERENCE

The present disclosure is a 371 national phase application of PCT Application No. PCT/CN2023/079641 filed Mar. 3, 2023, which claims priority to Chinese Patent Application No. 202210641066.3 filed on Jun. 8, 2022 and entitled “DISPLAY CONTROL METHOD AND DEVICE FOR VIRTUAL OBJECT, STORAGE MEDIUM, AND ELECTRONIC DEVICE,” the entire contents of both of which applications are hereby incorporated by reference for all purposes.

### TECHNICAL FIELD

The present disclosure relates to the field of computers, and in particular to a display control method and device for a virtual object, a storage medium, and an electronic device.

### BACKGROUND

Currently, in a game application, a method of selecting to view internal resources of a virtual building is usually directly clicking on the virtual building on a big map to jump to the interior of the virtual building. For example, it is required to enter the building to view troops in the virtual building, and only the troops in the current building can be displayed at the same time.

In the related art, when moving internal resources of a current virtual building to another virtual model, it is necessary to switch back and forth between different buildings. However, this method requires frequent entry and exit, cumbersome operations, and has low efficiency.

To address the above problems, no effective solution has been proposed yet.

### SUMMARY

According to a first aspect, the present disclosure provides a display control method for a virtual object, the method comprising: displaying, in a graphical user interface provided by a terminal device, a first virtual scene picture corresponding to a first scale, where the first virtual scene picture includes a virtual model, and where the virtual model is located in a virtual scene displayed by the graphical user interface; displaying, in the graphical user interface, a target virtual scene picture corresponding to a target scale and an object control in response to a first operation of switching the first scale to the target scale, where the target virtual scene picture includes a virtual model set to which the virtual model belongs, and the object control is used for indicating a virtual controlled object associated with the virtual model in the virtual model set; and controlling, in response to a second operation on the object control, the virtual controlled object corresponding to the object control to move from a first virtual model to which the virtual controlled object belongs, to a second virtual model in the virtual model set.

According to a second aspect, the present disclosure provides one or more non-transitory computer-readable storage media containing, in any combination, computer program code that, when executed by a computer system, performs the operations in the above method for display control of a virtual object.

According to a third aspect, the present disclosure provides a system, comprising one or more memories collectively containing one or more programs, and one or more processors, where the one or more processors are configured to, individually or collectively, perform the operations in the above method for display control of a virtual object.

### BRIEF DESCRIPTION OF THE DRAWINGS

FIG. 1 is a block diagram of hardware configuration of a mobile terminal of a display control method for a virtual object, according to one embodiment of the present disclosure;

FIG. 2 is a flowchart of a display control method for a virtual object, according to one embodiment of the present disclosure;

FIG. 3 is a schematic diagram of entering a global viewing mode, according to one embodiment of the present disclosure;

FIG. 4 is a schematic diagram of moving a virtual object, according to one embodiment of the present disclosure;

FIG. 5 is a block diagram of a configuration of a display control device for a virtual object, according to one embodiment of the present disclosure; and

FIG. 6 is a schematic diagram of an electronic device, according to one embodiment of the present disclosure.

### DETAILED DESCRIPTION

In order that those skilled in the art can better understand the solution in the present disclosure, the technical solutions in the embodiments of the present disclosure will be described clearly and completely with reference to the accompanying drawings in the embodiments of the present disclosure. It is apparent that the described embodiments are merely a part of rather than all the embodiments of the present disclosure. Based on the embodiments of the present disclosure, all other embodiments derived by those of ordinary skill in the art without creative efforts shall fall within the protection scope of the present disclosure.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

The terms such as “first” and “second” in the specification, the claims, and the accompanying drawings of the present disclosure are used to distinguish similar objects, and are not necessarily used to describe a specific sequence or order. It should be understood that data used in such manner can be exchanged in proper situations, so that the embodiments of the present disclosure described here can be implemented in sequences other than those shown or described herein. Moreover, the terms “include” and “have” and any variation of them are intended to cover non-exclusive inclusion. For example, a process, method, system, product or device including a series of steps or units is not necessarily limited to those steps or units clearly listed, but can include other steps or units that are not clearly listed or are inherent to the process, method, product or device. Additionally, depending on the context, the term “if” used herein may be explained as “when” or “while”, or “in response to . . . , it is determined that.”

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components that are directly or indirectly linked together, so as to perform a particular function.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

In some embodiments of the present disclosure, the first virtual scene picture corresponding to the first scale is displayed in the graphical user interface; the target virtual scene picture corresponding to the target scale and the object control are displayed in the graphical user interface in response to the first operation of switching the first scale to the target scale; and the virtual controlled object corresponding to the object control is controlled, in response to the second operation on the object control, to move from the first virtual model to which the virtual controlled object belongs, to the second virtual model in the virtual model set. By displaying, in the graphical user interface, the target virtual scene picture corresponding to the target scale and the object control, the embodiments of the present disclosure enable an overview of all virtual models and their distribution across the entire map on a single screen, thereby improving the control efficiency of the virtual controlled object.

First, apart of nouns or terms involved in the description of embodiments of the present disclosure are applicable to the following explanations:
Player VS Player (PVP for short) may refer to a battle between players;
Global viewing mode may refer to a map viewing mode for viewing all own-side buildings and troop information inside the buildings;
Simulation Game (SLG for short) may refer to strategy games, which may be a derivative type of simulation games;
Virtual buildings may refer to building facilities in a game that can accommodate own-side military units, and may include fortresses, field fortresses, large fortresses, military barracks, branch cities, scout barracks, reserve barracks, and the like.

According to one embodiment of the present disclosure, an embodiment of a display control method for a virtual object is provided. It should be noted that steps shown in the flowchart of the accompanying drawings may be performed in a computer system such as a set of computer executable instructions, and although a logical order is shown in the flowchart, in some embodiments, the steps shown or described may be performed in an order different from that shown here.

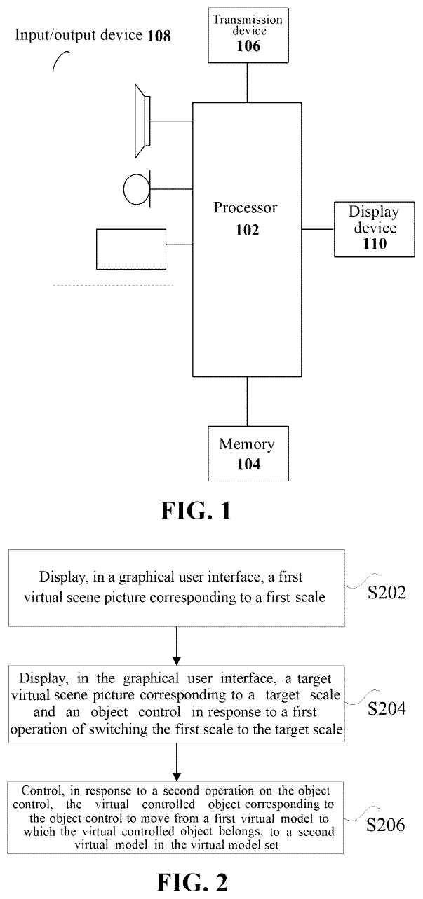

The method embodiment may be performed in a mobile terminal, a computer terminal or a similar computing device. Taking running on a mobile terminal as an example, the mobile terminal may be a smart phone (such as an Android phone and an iOS phone), a tablet computer, a Personal Digital Assistant (PAD), a Mobile Internet Device (MID for short), a game console, or another terminal device. FIG. 1 is a block diagram of hardware configuration of a mobile terminal of a display control method for a virtual object, according to one embodiment of the present disclosure. As shown in FIG. 1, the mobile terminal may include one or a plurality of (only one is shown in FIG. 1) processors 102 (the processor 102 may include but is not limited to a processing device such as a Central Processing Unit (CPU for short), a Graphics Processing Unit (GPU for short), a Digital Signal Processing (DSP for short) chip, a Microcontroller Unit (MCU for short), a Field Programmable Gate Array (FPGA for short), a Neural Network Processing Unit (NPU for short), a Tensor Processing Unit (TPU for short), and an Artificial Intelligence (AI for short) type processor) and a memory 104 for storing data. In some embodiments, the mobile terminal may further include a transmission device 106, an input/output device 108, and a display device 110 for communication functions. Those of ordinary skill in the art may appreciate that the configuration shown in FIG. 1 is merely illustrative and does not limit the configuration of the mobile terminal. For example, the mobile terminal may further include more or fewer components than those shown in FIG. 1, or have a configuration different from that shown in FIG. 1.

In some embodiments of the present disclosure, the memory 104 may be used for storing computer programs, for example, software programs and modules of application software, such as a computer program corresponding to the display control method for a virtual object. The processor 102 performs various functional applications and data processing by running the computer programs stored in the memory 104, thereby realizing the above display control method for a virtual object. The memory 104 may include a high-speed random access memory, and may also include a non-volatile memory, such as one or a plurality of magnetic storage devices, flash memories, or other non-volatile solid-state memories. In some examples, the memory 104 may further include memories remotely located relative to the processor 102, and these remote memories may be connected to the mobile terminal via a network. Examples of the above network include, but are not limited to, the Internet, an intranet, a local area network, a mobile communication network, and a combination thereof.

The transmission device 106 is used for receiving or sending data via a network. A specific example of the above network may include a wireless network provided by a communication provider of the mobile terminal. In one example, the transmission device 106 includes a Network Interface Controller (NIC for short), which may be connected to another network device through a base station so as to communicate with the Internet. In one instance, the transmission device 106 may be a Radio Frequency (RF for short) module, which is used for communicating with the Internet in a wireless manner.

Inputs in the input/output device 108 may come from a plurality of Human Interface Devices (HIDs for short), for example, a keyboard and a mouse, a game controller, and other dedicated game controllers (such as a steering wheel, a fishing rod, a dance mat, and a remote control). In addition to providing input functions, some human interface devices may also provide output functions, such as force feedback and vibration of a game controller and audio output of a controller.

The display device 110 may be, for example, a Head Up Display (HUD for short), a touch screen Liquid Crystal Display (LCD for short), and a touch display (also referred to as a “touch screen” or a “touch display screen”). The liquid crystal display may enable a user to interact with a user interface of the mobile terminal. In some embodiments, the mobile terminal has a Graphical User Interface (GUI for short), and a user may perform human-computer interaction with the GUI through finger contacts and/or gestures touching on a touch-sensitive surface. In some embodiments, the human-computer interaction functions here may include the following interactions: creating web pages, drawing, word processing, making electronic documents, games, video conferencing, instant messaging, sending and receiving emails, call interface, playing digital videos, playing digital music and/or web browsing, and the like. Executable instructions for executing the above human-computer interaction functions are configured/stored in a computer program product or readable storage medium executable by one or a plurality of processors.

According to one embodiment of the present disclosure, a display control method for a virtual object is provided, where a graphical user interface is provided by a terminal device, and display content of the graphical user interface includes a virtual scene and a plurality of virtual models located in the virtual scene. The terminal device may be the local terminal device mentioned above, or may be a client device in the cloud interaction system mentioned above. The virtual scene may be a game scene. The virtual model may be a building facility in the game scene, or may be an enclosed space in which the building facility is placed in the game scene.

FIG. 2 is a flowchart of a display control method for a virtual object, according to one embodiment of the present disclosure. As shown in FIG. 2, the method may include the following steps:

Step S202: Display, in the graphical user interface, a first virtual scene picture corresponding to a first scale, where the first virtual scene picture includes at least one virtual model.

In the technical solution provided in the above step S202 of the present disclosure, the first virtual scene picture may be displayed in the graphical user interface according to the first scale, where the first scale may be a value setup according to actual needs, the first virtual scene picture may be a virtual scene picture including any one of own-side buildings, and the virtual model may include a building model and the like.

In some embodiments, according to the needs of a user terminal itself, the first virtual scene picture may be displayed in the graphical user interface according to a pre-set or selected first scale, so as to achieve the purpose of displaying the virtual scene picture to be viewed.

Step S204: Display, in the graphical user interface, a target virtual scene picture corresponding to a target scale and an object control in response to a first operation of switching the first scale to the target scale, where the target virtual scene picture includes a virtual model set to which the virtual model belongs, and the object control is used for indicating a virtual controlled object associated with the virtual model in the virtual model set.

In the technical solution provided in the above step S204 of the present disclosure, the first scale may be switched to the target scale through the first operation. In response to the first operation of switching the first scale to the target scale, the target virtual scene picture corresponding to the target scale and the object control are displayed in the graphical user interface, where the first operation may be an operation on the graphical user interface, and the selection operation may be an operation generated by the user touching the virtual scene picture that allows selection on a big map displayed by the graphical user interface, such as a long press touch operation, a single click touch operation, a double click touch operation, and a sliding operation. For example, the virtual scene picture may be switched from the first scale to the target scale through a sliding operation on the graphical user interface, and so on. No specific limitation is made to the first operation herein, and any method, as long as being capable of switching the virtual scene picture from the first scale to the target scale, should fall within the protection scope of the embodiments of the present disclosure. The target scale may be a scale selected according to the needs of the user terminal, the target virtual scene picture may be an interface finally displayed in the graphical user interface, and the object control may be used for indicating the virtual controlled object associated with the virtual model in the virtual model set, for example, it may be indicated in the form of “bubble+line”.

In some embodiments, the virtual controlled objects in the virtual scene picture may be displayed in the form of “bubble+line” attached around the virtual scene picture. For example, at least one virtual controlled object associated with the virtual model may be viewed through bubbles outside the virtual scene picture on the graphical user interface.

In some embodiments, the first virtual scene picture corresponding to the first scale is displayed in the graphical user interface, and through the first operation, the virtual scene picture is switched from the first scale to the target scale, so that the target virtual scene picture corresponding to the target scale and the object control are displayed in the graphical user interface. The virtual scene picture may be a virtual scene picture in which any one of the own-side buildings exists. For example, a sliding is performed on the first virtual scene picture, and in response to the sliding operation on the first virtual scene picture, the first virtual scene picture at the first scale is switched to the target virtual scene picture at the target scale, where the target virtual scene picture corresponding to the target scale and the object control are displayed in the graphical user interface.

For example, global information may be displayed on the graphical user interface at the first scale, and the graphical user interface may be scaled up and down by sliding operations on the graphical user interface, so that the graphical user interface is switched from the first scale to the target scale, thereby achieving the purpose of displaying the target virtual scene picture corresponding to the target scale and the object control in the graphical user interface.

In the related art, all virtual buildings are displayed on a big map, thereby providing an overview of information on all the virtual buildings. When resources of a virtual building need to be transferred to another virtual building, it needs to click on the virtual building on the big map interface to enter the virtual building to view the resources, select to transfer the resources to another virtual building, return to the big map interface, drag the scene picture in the big map interface to another virtual building, and click to enter the other virtual building to manipulate the transferred resources. This method requires switching back and forth, and there are problems such as frequent entry and exit and cumbersome operation. In some embodiments of the present disclosure, a portion of the first virtual scene picture is displayed at the first scale, and the graphical user interface is displayed at different scales in response to the first operation, so that the display content of the graphical user interface can be used to overview display and manipulate the virtual controlled object transferred between different virtual buildings, thereby avoiding the problems such as frequent entry and exit and cumbersome operation caused by switching back and forth between scene pictures of different virtual buildings.

Step S206: Control, in response to a second operation on the object control, the virtual controlled object corresponding to the object control to move from a first virtual model to which the virtual controlled object belongs, to a second virtual model in the virtual model set.

In the technical solution provided in the above step S206 of the present disclosure, the second operation is performed on the object control in the target virtual scene picture, and in response to the second operation on the object control, the virtual controlled object corresponding to the object control is controlled to move from the first virtual model to which it belongs, to the second virtual model in the virtual model set, where the second operation may be an operation of controlling the virtual controlled object to move, for example, it may be a sliding operation of moving the object control to the second virtual model, or a clicking operation of selecting the object control and the second virtual model in sequence, and the like. The virtual model set may include at least one virtual controlled object associated with the virtual model, and some virtual models may have no associated virtual controlled objects. Each virtual model in the virtual model set and at least one virtual controlled object respectively associated with at least one virtual model in the virtual model set are displayed on the graphical user interface, so as to realize an overview of the distribution of the virtual models and virtual controlled objects associated with the virtual models. The virtual controlled objects may be troops in the virtual models or other game resources, such as heroes and warships. The position of the virtual controlled object in the virtual scene is in a movable state, and the virtual controlled object may be mobilized between virtual models. The first virtual model may be the virtual model that currently needs to transfer resources, and the second virtual model may be another virtual model in the virtual model set other than the first virtual model.

In some embodiments, the first virtual scene picture corresponding to the first scale may be displayed in the graphical user interface, and the game enters a global viewing mode. In the global viewing mode, the virtual model is displayed on the graphical user interface at the first scale. In response to the first operation, the virtual scene picture is switched from the first scale to the target scale, and the target virtual scene picture corresponding to the target scale and the object control are displayed in the graphical user interface. The second operation is performed on the object control in the target virtual scene picture. In response to the second operation on the object control, the virtual controlled object corresponding to the object control is controlled to move from the first virtual model to the second virtual model in the virtual model set.

In some embodiments, the position of the virtual controlled object in the virtual scene is in the movable state. For example, the position of the virtual controlled object in the virtual scene may be moved by the second operation in the virtual scene.

For example, the object control on the first virtual scene picture may be pressed to be dragged. When a dragging distance is greater than a certain value, a connection line between a bubble of the virtual controlled object and a building is disconnected. When the virtual controlled object is dragged to the second virtual model in the virtual model set, a building dragging and placement region is highlighted and activated, and the bubble of the virtual controlled object entering the second virtual model is automatically attached and a connection line is generated. A confirmation pop-up window pops up, and after confirm is clicked, a dynamic trajectory may appear between the first virtual model and the second virtual model, and the object control of the virtual controlled object moves between the first virtual model and the second virtual model along the trajectory.

In some embodiments of the present disclosure, by the first operation, quick switch between a local picture and a global picture is achieved, and by displaying the object control in the first virtual scene picture that globally displays the virtual models, the purpose of quickly scheduling virtual controlled object between different virtual models is may be achieved by the second operation on the object control.

By the steps S202 to S206, in some embodiments of the present disclosure, the first virtual scene picture corresponding to the first scale is displayed in the graphical user interface; the target virtual scene picture corresponding to the target scale and the object control are displayed in the graphical user interface in response to the first operation of switching the first scale to the target scale; and the virtual controlled object corresponding to the object control is controlled, in response to the second operation on the object control, to move from the first virtual model to which the virtual controlled object belongs, to the second virtual model in the virtual model set. In other words, the present disclosure displays, in the graphical user interface, the target virtual scene picture corresponding to the target scale and the object control, so that all virtual models and their distribution on the entire map can be overviewed on one screen, and scheduling of the virtual controlled object between different virtual models may be achieved by the object control, thereby improving the control efficiency of the virtual controlled object.

In some embodiments, in step S204, the first operation is a selection operation on at least one virtual model, and the target scale is a second scale. The displaying, in the graphical user interface, a target virtual scene picture corresponding to a target scale and an object control in response to a first operation of switching the first scale to the target scale includes: acquiring, in response to the selection operation on the at least one virtual model, the virtual model set to which the selected virtual model belongs; determining the second scale corresponding to the virtual model set, where the second scale enables the virtual model set to be completely displayed in the graphical user interface; and displaying, in the graphical user interface, a second virtual scene picture corresponding to the second scale and the object control, where the target virtual scene picture includes the second virtual scene picture.

In some embodiments, the graphical user interface may be switched from the first scale to the target scale through the first operation, and the target virtual scene picture corresponding to the target scale and the object control are displayed in the graphical user interface. The target virtual scene picture includes at least one virtual model, and the target virtual scene model picture is selected. In response to the selection operation on the at least one virtual model, the virtual model set to which the selected virtual model belongs is acquired, and the scale at which the virtual model set can be completely displayed in the graphical user interface is determined to obtain the second scale. The second virtual scene picture corresponding to the second scale and the object control are displayed in the graphical user interface, where the target virtual scene picture includes the second virtual scene picture.

In some embodiments, a selection operation is performed on at least one virtual model to obtain the selected virtual model set, the obtained virtual model set is completely displayed in the graphical user interface according to the second scale to obtain the second virtual scene picture, and the object control corresponding to the virtual model is displayed in the second virtual scene picture.

In some embodiments, the second scale is determined in the following manner: scaling down, according to a preset scaling amplitude, the virtual model set displayed at the first scale until all virtual models in the virtual model set are completely displayed in the graphical user interface; and determining the corresponding scale when all virtual models in the virtual model set are completely displayed in the graphical user interface as the second scale.

In some embodiments, the virtual model set displayed at the first scale may be scaled down according to the preset scaling amplitude until all virtual models in the virtual model set are completely displayed in the graphical user interface. The corresponding scale when all virtual models in the virtual model set are completely displayed in the graphical user interface is determined as the second scale.

In some embodiments, virtual models may be selected, all selected virtual models may be taken as a virtual model set, and the virtual model set may be displayed on the graphical user interface at the second scale.

In some embodiments, the first operation is a scaling operation on the first virtual scene picture, and the target scale is a third scale. The displaying, in the graphical user interface, a target virtual scene picture corresponding to a target scale and an object control in response to a first operation of switching the first scale to the target scale includes: determining, in response to the scaling operation on the first virtual scene picture, the third scale corresponding to the scaling operation; determining virtual models existing in a third virtual scene picture at the third scale, and determining the virtual models existing in the third virtual scene picture as a virtual model set; determining a virtual controlled object associated with a virtual model in the virtual model set; and displaying, in the graphical user interface, the third virtual scene picture at the third scale and the object control corresponding to the virtual controlled object, where the target virtual scene picture includes the third virtual scene picture.

In some embodiments, the scaling operation may be performed on the virtual scene picture. In response to the scaling operation on the first virtual scene picture, the third scale corresponding to the scaling operation is determined, virtual models existing in the third virtual scene picture at the third scale are determined to obtain the virtual model set, and the virtual controlled object associated with the virtual model in the virtual model set is determined. The third virtual scene picture at the third scale and the object control corresponding to the virtual controlled object are displayed in the graphical user interface. The target virtual scene picture includes the third virtual scene picture. The scaling operation may be an operation of scaling down or up the virtual scene picture. For example, a sliding operation may be performed on the graphical user interface with two fingers to control a virtual camera lens to zoom in or out, thereby achieving the purpose of scaling down or up the virtual scene picture.

In some embodiments, the virtual scene picture may be scaled down or up according to the scaling amplitude of the scaling operation, the virtual models that can be accommodated in the current virtual scene picture and need to be displayed are taken as a virtual model set to obtain the virtual model set, and the virtual controlled object associated with the virtual model in the virtual model set is determined. The third virtual scene picture at the third scale and the object control corresponding to the virtual controlled object are displayed in the graphical user interface. The virtual model set may be all of the virtual models or part of the virtual models, for example, all of the virtual models may be displayed when it is scaled down to a small enough size.

In some embodiments, the second operation on the object control may include: a dragging operation from the object control to a response region of the second virtual model, where the response region includes at least one of the second virtual model or a model peripheral region within a preset range of the second virtual model.

In some embodiments, the object control may be moved to the response region of the second virtual model by the dragging operation. The response region may be the second virtual model, or may include the second virtual model and the model peripheral region located in the preset range of the second virtual model.

In some embodiments, the response region may be determined on the graphical user interface, and at least one virtual controlled object associated with the virtual model may be displayed in the response region, so as to display, on the graphical user interface, at least one virtual controlled object associated with the virtual model in the virtual model set, where the response region may be the periphery of the virtual model (such as a building). It should be noted that not every virtual model has an associated virtual controlled object, and a virtual controlled object may be mobilized to a virtual model that is not associated with a virtual controlled object. For example, troops may be mobilized to an empty virtual model.

In some embodiments, in the response region on the graphical user interface, a virtual object whose center point is in the response region is determined to obtain the virtual controlled object, and at least one virtual controlled object is displayed in the response region to implement the drag operation, from the object control to the response region of the second virtual model, of the at least one virtual controlled object associated with the virtual model in the virtual model set displayed on the graphical user interface.

For example, a geometric center point of the second virtual model may be used as the center of circle, and the radius may be set to draw a circle, so as to obtain the model peripheral region of the second virtual model within the preset range. Based on the second model and/or the model peripheral region of the second virtual model within the preset range, the response region of the second virtual model is obtained, and the object control is dragged to the response region of the second virtual model to achieve the purpose of moving the virtual object to the second virtual model.

In some embodiments, the target virtual scene picture includes an object identifier corresponding to the virtual controlled object. The controlling the virtual controlled object corresponding to the object control to move from a first virtual model to which the virtual controlled object belongs, to a second virtual model in the virtual model set includes: generating, in the target virtual scene picture, a first trajectory route from the first virtual model to the second virtual model; and synchronously controlling, according to a moving progress of the virtual controlled object, the object identifier to move along the first trajectory route.

In some embodiments, the target virtual scene picture includes the object identifier corresponding to the virtual controlled object, where the object identifier may be used for indicating the corresponding virtual controlled object, as well as a relationship identifier between the virtual controlled object and the corresponding virtual scene picture. The virtual controlled object may be displayed in the response region through the object identifier, and the object identifier may be displayed in the form of “bubble+line” attached around the virtual building.

In some embodiments, the first trajectory route from the first virtual model to the second virtual model is generated in the target virtual scene picture. The object identifier is synchronously controlled, according to a moving progress of the virtual controlled object, to move along the first trajectory route, so as to achieve the purpose of controlling the virtual controlled object corresponding to the object control to move from the first virtual model to which the virtual controlled object belongs, to the second virtual model in the virtual model set. The first trajectory route may be a dynamic trajectory, which may be used for guiding the first virtual model to which the object identifier belongs, to move to the second virtual model in the virtual model set.

In some embodiments, when it is determined that the virtual controlled object moves from the first virtual model to the second virtual model, the dynamic trajectory is displayed on the graphical user interface, and the object identifier of the virtual controlled object moves along the dynamic trajectory from the first virtual model to which the virtual controlled object belongs, to the second virtual model in the virtual model set.

It should be noted that, in the related art, the virtual controlled object (troop) associated with the virtual model (building) can be determined only by positioning and moving to the virtual scene picture to be moved to, while in some embodiments of the present disclosure, there is no need to move to the virtual model (building), and all virtual controlled objects (troops) associated with the virtual model (building) may be determined through bubbles outside the virtual model.

In some embodiments, the target virtual scene picture includes a first relationship identifier corresponding to the virtual controlled object, and the first relationship identifier is used for indicating the belonging relationship between the virtual controlled object and the first virtual model. The method further includes: canceling, in response to a distance between the moved object identifier and the first virtual model being greater than a first distance threshold, display of the first relationship identifier in the target virtual scene picture; and displaying, in response to a distance between the moved object identifier and the second virtual model being less than a second distance threshold, a second relationship identifier in the target virtual scene picture, where the second relationship identifier is used for indicating the belonging relationship between the virtual controlled object and the second virtual model.

In some embodiments, the target virtual scene picture includes the first relationship identifier corresponding to the virtual controlled object, where the first relationship identifier may be used for indicating the belonging relationship between the virtual controlled object and the first virtual model. For example, the belonging relationship between the virtual controlled object and the first virtual model may be indicated in the form of a line. The target virtual scene picture may include a first virtual scene model and a second virtual model, and the first virtual scene model is associated with at least one virtual controlled object via the first relationship identifier, where the virtual controlled object may be an object to be mobilized in the virtual scene picture.

In some embodiments, a moving operation is performed on the object identifier, and in response to the distance between the moved object identifier and the first virtual model being greater than the first distance threshold, display of the first relationship identifier in the target virtual scene picture is canceled. In response to the distance between the moved object identifier and the second virtual model being less than the second distance threshold, the second relationship identifier is displayed in the target virtual scene picture, where the second relationship identifier is used for indicating the belonging relationship between the virtual controlled object and the second virtual model.

In some embodiments, the target virtual scene picture is determined, the object identifier of the virtual controlled object associated with the first virtual model is moved to the second virtual model, and when the distance between the moved object identifier and the first virtual model is greater than the first distance threshold, display of the first relationship identifier in the target virtual scene picture is canceled. When the distance between the moved object identifier and the second virtual model is less than the second distance threshold, in response to the distance between the moved object identifier and the second virtual model being less than the second distance threshold, the second relationship identifier in the target virtual scene picture is established.

In some embodiments, the object identifier of the virtual controlled object is moved from the response region of the first virtual model to the response region of the second virtual model to achieve the purpose of moving the virtual controlled object from the response region of the first virtual model to the response region of the second virtual model. The object identifier may be used for indicating the corresponding target virtual controlled object and the first relationship identifier or the second relationship identifier. For example, the virtual controlled object is attached around the building in the form of “bubble+line”, the bubble may be used for indicating the controlled object control, and the line may be used for indicating the relationship identifier between the virtual controlled object and the virtual model.

For example, the virtual controlled object is attached in the response region of the virtual model in the form of “bubble+line”. The purpose of moving the virtual controlled object from the first virtual model to the second virtual model may be achieved by moving the bubble of the target virtual controlled object from the response region of the first virtual model to the response region of the second virtual model.

For example, when the user intends to mobilize the virtual controlled object in the first virtual model to the second virtual model, the object identifier attached on the second virtual model may be moved. When the moving distance of the object identifier is greater than the first distance threshold, a connection line between the bubble in the object identifier and the first virtual model is disconnected, and the display of the first relationship identifier in the target virtual scene picture is canceled. When the target virtual controlled object is dragged to the response region of the second virtual model, the response region of the second virtual model may be highlighted and activated, and the bubble in the object identifier of the virtual controlled object entering the response region is automatically attached by the second virtual model and the second relationship identifier is generated. The second relationship identifier is displayed in the target virtual scene picture to establish the belonging relationship between the virtual controlled object and the second virtual model.

In some embodiments, the displaying, in the graphical user interface, a target virtual scene picture corresponding to a target scale in response to a first operation of switching the first scale to the target scale includes: controlling, in response to the first operation of switching the first scale to the target scale, scene elements in the virtual scene other than the virtual model set to perform a first size transformation according to the target scale, and controlling the virtual model set to perform a second size transformation according to a fourth scale, where the fourth scale is smaller than the target scale; and displaying the target virtual scene picture in the graphical user interface, where the target virtual scene picture includes the scene elements that have been subjected to the first size transformation according to the target scale, and the virtual model set that has been subjected to the second size transformation according to the fourth scale.

In some embodiments, in response to the first operation of switching the first scale to the target scale, the scene elements in the virtual scene other than the virtual model set are controlled to perform the first size transformation according to the target scale, the virtual model set is controlled to perform the second size transformation according to the fourth scale, and the scene elements that have been subjected to the first size transformation according to the target scale and the target virtual scene picture of the virtual model set that has been subjected to the second size transformation according to the fourth scale are displayed in the graphical user interface, where the fourth scale is smaller than the target scale. The scene elements may be coordinate points corresponding to the virtual models.

In some embodiments, in response to the first operation of switching the first scale to the target scale, the scene elements in the virtual scene other than the virtual model set are controlled to perform the first size transformation according to the target scale, a scale smaller than the target scale is determined as the fourth scale, and the virtual model set is controlled to perform the second size transformation according to the fourth scale to obtain the target virtual scene picture.

In some embodiments, in response to the first operation of switching the first scale to the target scale, the scene elements in the virtual scene other than the virtual model set are controlled to be proportionally scaled to a first size according to the target scale to obtain a transformed graphical user interface. The scaled virtual scene picture may be displayed in the center of the graphical user interface, so that all virtual scene pictures can be overviewed in one graphical user interface.

In some embodiments, the virtual scene picture may be scaled at the target scale (X), and a scale smaller than the target scale is determined as the fourth scale (Y). Therefore, X>Y in the proportional scaling.

In some embodiments, a target geometric region is determined based on position information of each virtual model in the virtual model set in the virtual scene, where the target geometric region includes the position information of each virtual model in the virtual scene; and the target scale is determined based on the side length of the target geometric region.

In some embodiments, the target geometric region is determined based on the position information of each virtual model in the virtual model set in the virtual scene, and the target scale is determined based on the side length of the target geometric region, where the target geometric region may be a rectangle, which is only used as an example and does not impose any specific limitations on the shape of the geometric region. The target scale may be used for indicating a multiple or ratio of an original virtual scene size, which may be indicated by X.

In some embodiments, the position information of each virtual model in the virtual scene is determined, the target geometric region is determined based on the position information, the target scale is determined based on the side length of the target geometric region, and the size of each original virtual scene picture is scaled based on the target scale to obtain each virtual scene picture, where the position information may be a coordinate point of the original virtual model, such as a coordinate point of a building.

In some embodiments, the target scale is determined based on the position information, the scale smaller than the target scale is determined as the fourth scale, the scene elements in the virtual scene other than the virtual model set are controlled to be scaled based on the target scale, the size of each virtual model is scaled based on the fourth scale to obtain the target virtual scene picture, and the target virtual scene picture is displayed in the graphical user interface. The target virtual scene picture includes the scene elements that have been subjected to the first size transformation according to the target scale, and the virtual model set that has been subjected to the second size transformation according to the fourth scale.

In some embodiments, the user terminal may long press different virtual models to enter a global mode. Since the building coordinates are fixed in the game, a position display calculation method in the global mode is fixed. Therefore, the user terminal sees the same virtual scene, but the virtual controlled objects displayed in different virtual scene pictures may be different.

In some embodiments, the target geometric region is a rectangular region with the smallest area and including the position information of each virtual model in the virtual scene; and the determining the target scale based on the side length of the target geometric region includes: determining the longest side among a plurality of sides constituting the rectangular region, and determining a target side that matches the current resolution of the graphical user interface; and determining the target scale based on the longest side and the target side, where a ratio between the longest side after scaling the longest side according to the target scale and the target side meets a target ratio.

In some embodiments, the target geometric information is determined based on the position information, and the rectangular region with the smallest area is made. The longest side is determined among the plurality of sides that constitute the rectangular region, and the target side that matches the current resolution of the graphical user interface is determined. The target scale is determined based on the longest side and the target side, where the ratio between the longest side after scaling the longest side according to the target scale and the target side meets the target ratio. The rectangular region may be a rectangle with the smallest area.

For example, the position information (coordinate points) of the virtual models may be used as parameters to make the rectangle with the smallest area, so that all coordinate points are within the rectangle and both sides of the rectangle are parallel to the coordinate axis. At the same time, the longest side of the rectangle with the smallest area is exactly 80% of the side length corresponding to the current resolution after being scaled according to the target scale, thereby determining the target scale X. Each virtual model in the virtual model set may be scaled proportionally according to the target scale to obtain the target virtual scene picture. It should be noted that 80% here is only an example and is not specifically limited.

In some embodiments, a second trajectory route of at least one friend-side virtual controlled object and/or at least one enemy-side virtual controlled object is displayed on the graphical user interface in response to a starting point of movement of the at least one friend-side virtual controlled object and/or at least one enemy-side virtual controlled object of the virtual controlled object being in the target virtual scene picture, where the second trajectory route is used for indicating a complete path of movement of the corresponding friend-side virtual controlled object and/or enemy-side virtual controlled object in the target virtual scene picture.

In some embodiments, the second trajectory route of the at least one friend-side virtual controlled object and/or at least one enemy-side virtual controlled object is displayed on the graphical user interface in response to the starting point of the movement of the at least one friend-side virtual controlled object and/or at least one enemy-side virtual controlled object of the virtual controlled object being in the target virtual scene picture, where the second trajectory route is used for indicating the complete path of the movement of the corresponding friend-side virtual controlled object and/or enemy-side virtual controlled object in the target virtual scene picture.

In some embodiments, in the global mode, the starting point of the movement of the virtual controlled object is determined. When the starting point of the movement of the virtual controlled object is in the target virtual scene picture of the virtual scene, the second trajectory route of the virtual controlled object is displayed on the graphical user interface in response to the starting point of the movement of the virtual controlled object being in the target virtual scene picture, where the second trajectory route may be marching path information of the virtual controlled object, which may be used for indicating the complete path of the movement of the virtual controlled object in the target virtual scene picture of the virtual scene, and the range of the target virtual scene picture is determined by the range displayed by the virtual model set on the graphical user interface.

In some embodiments, when the starting point of the movement of the virtual controlled object is not in the target virtual scene picture, the displayed trajectory route of the friend-side virtual controlled object and/or enemy-side virtual controlled object is not the complete trajectory route, and only the trajectory part that enters the range of the own-side building in the target virtual scene picture can be seen.

In the related art, it is impossible to have a global understanding of the complete path of the movement, but in the embodiments of the present disclosure, when at least one friend-side virtual controlled object and/or enemy-side virtual controlled object of the virtual controlled object is displayed in the target virtual scene picture of the virtual scene, the complete path of the movement of the friend-side and/or enemy-side virtual controlled object in the target virtual scene picture can be displayed in the global mode.

In some embodiments of the present disclosure, the range of the target virtual scene picture is determined by the range displayed by the virtual model set on the graphical user interface, and therefore, when the starting point of the movement of the virtual controlled object is outside the target virtual scene picture of the virtual scene, its trajectory route is incomplete at this point, and only the trajectory route after entering the target virtual scene picture is displayed. It is further explained that the trajectory route of the virtual controlled object is not necessarily complete. Only when the starting point of the movement of the virtual controlled object is in the target virtual scene picture of the virtual scene, can the complete path of the movement of the virtual controlled object in the target virtual scene picture of the virtual scene be displayed on the graphical user interface.

In some embodiments, the first virtual scene picture corresponding to the first scale is displayed in the graphical user interface; the target virtual scene picture corresponding to the target scale and the object control are displayed in the graphical user interface in response to the first operation of switching the first scale to the target scale; and the virtual controlled object corresponding to the object control is controlled, in response to the second operation on the object control, to move from the first virtual model to which the virtual controlled object belongs, to the second virtual model in the virtual model set. In other words, the present disclosure displays, in the graphical user interface, the target virtual scene picture corresponding to the target scale and the object control, so that all virtual models and their distribution on the entire map can be overviewed on one screen, and scheduling of the virtual controlled object between different virtual models may be achieved by the object control, thereby improving the control efficiency of the virtual controlled object.

The technical solution of the embodiments of the present disclosure is further introduced below with examples. Specifically, illustration is made by taking the above virtual model being a building model as an example, and a global visualization method for calling and viewing troops in a building is provided.

Currently, in strategy games, users' troops may be mobilized to virtual buildings on various maps. The troops may go out to battle from the virtual buildings or be mobilized between the virtual buildings. For example, the troops may be mobilized to virtual buildings such as fortresses, military barracks, and branch cities. The users may select virtual buildings and then execute mobilization commands to mobilize corresponding troops.

In the related art, the selection of a virtual building is carried out by directly jumping on a big map. If a user intends to move from one virtual building to another virtual building, he/she needs to swipe on the big map to find it, or use a mark positioning to jump on the big map. The viewing/mobilization of troops usually uses a progressive operation of a plurality of clicks: one click for, entering from the big map interface outside the virtual building to the interface inside the virtual building, one click for entering from the interface inside the virtual building to the current troop interface, and one click for selecting the troop for mobilization. The viewing of troop marching information can only be done by viewing the marching troops on the big map. If the departure place or destination is beyond the graphical user interface, it is necessary to swipe in the corresponding direction to move the map perspective to view it.

However, in the above method, the user needs to locate or find, on the map, a target virtual building that needs to be mobilized, click on the virtual building that needs to be mobilized, select the troop in the virtual building to enter a mobilization command interface, and finally click for mobilization. The whole process needs to display 3 interfaces and requires a plurality of steps. For example, if the user intends to view the distribution of his/her own-side troops in the virtual building, he/she needs to locate or find the corresponding virtual building on the map, click on the virtual building and then click on the city button to enter the city for viewing. If the user intends to quickly view the distribution of troops in the virtual buildings, he/she needs to frequently switch in and out of the virtual buildings for viewing. Therefore, there is a technical problem that when the user mobilizes troops between his/her own-side virtual buildings, the process is long, and the operation cost is high.

Furthermore, although the current interaction solution is more in line with the user's general cognition and the single-click interaction operation is low in cost, it has the following disadvantages in scenarios where high-frequency mobilization of troops or large-scale battles are required, which are time-sensitive and require interaction efficiency: in the case of virtual building selection interaction, the virtual buildings on the big map cannot be displayed in one graphical user interface, and the user needs to slide the graphical user interface to bring a target virtual building into the graphical user interface perspective, and the interaction is cumbersome. When the virtual buildings on the map are far apart, it may be necessary to jump through virtual building markers. The jump interaction operation is complicated and the jump process is not instantaneous, and the immediacy is poor. At the same time, the virtual buildings of many users are displayed extremely densely on the graphical user interface, and it is not clear and intuitive enough for users to identify and locate their own fortresses. In the case of viewing and interacting with troops, the current interaction requires entering the virtual building each time to view the troops in the virtual building. The entering and exiting interaction is cumbersome, and only the troops in one virtual building can be displayed at the same time. When the user needs to consider the overall deployment of troops, there are problems of being not intuitive and clear enough, and being incapable of displaying the global information. In the case of troop mobilization, it is necessary to frequently enter and exit the virtual buildings to select troops, which has a high operating cost. The entire operation process is all click operations, and the user's sense of manipulation and control over the situation is weak. In some embodiments, the viewing marching information, the departure place and destination cannot be displayed in the same graphical user interface, and therefore, only part of the marching path can be displayed on the big map, and there is no global understanding of the entire marching path information.

In response to the above problems, the present disclosure utilizes a displaying form of presenting the otherwise three levels of relationships among the big map, cities, and troops at the same level through perspective, and an interaction form of attaching the troops around the virtual buildings as bubbles and mobilizing the troops by dragging them to the objects, thereby greatly improving the user's viewing and mobilization efficiency of own-side virtual buildings and the troops inside the virtual buildings. At the same time, compared to the previous continuous switching, dragging and mobilizing troops from the global perspective improves the user's sense of manipulation and control over the situation.

The above method of the embodiment is further introduced below.

In some embodiments, all virtual building coordinate points of the own side are used as parameters to make a rectangle with the smallest area, so that all the coordinate points are located within the rectangle, and both sides of the rectangle are parallel to the coordinate axis. At the same time, the rectangle with the smallest area meets: after the longer side, after being scaled at a ratio of 1:X, is exactly 80% of the side length corresponding to the current resolution to determine the value of X, the big map is scaled at the ratio of 1:X and displayed in the global viewing mode.

In some embodiments, the scaled rectangular region is displayed in the center of the graphical user interface, the virtual building in the map is scaled at a ratio of 1:Y, and the rest of the image is displayed at a fixed ratio, where X>Y.

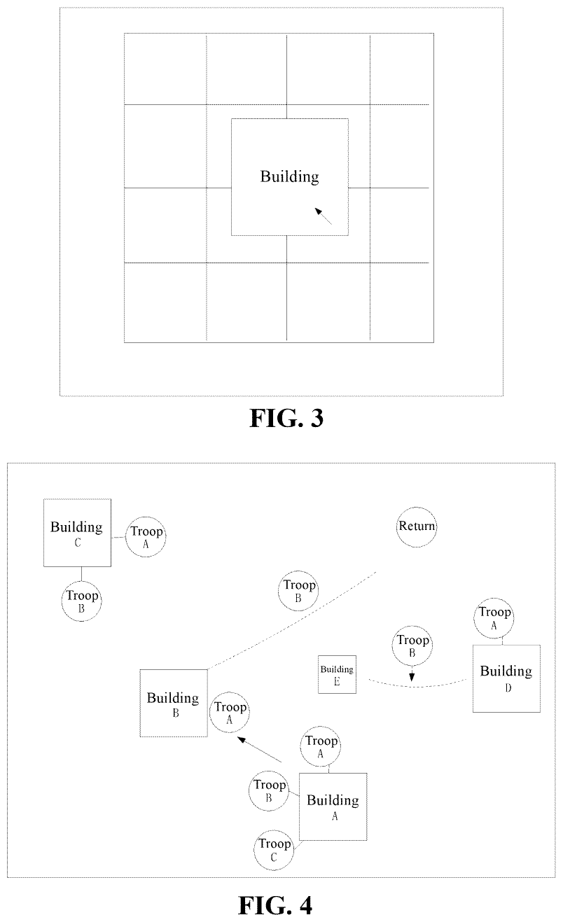

In the present disclosure, FIG. 3 is a schematic diagram of entering a global viewing mode, according to one embodiment of the present disclosure. As shown in FIG. 3, the global viewing mode is entered by long pressing any own-side virtual building on the big map. In the global viewing mode, all own-side virtual buildings are displayed on the graphical user interface with the maximum display range, and troops in the own-side virtual buildings are displayed in the form of bubbles+lines attached around the virtual buildings. A big map interface may be returned to by clicking a return button.

It should be noted that in the related art, only by locating and moving to a virtual building can troops in the virtual building be viewed, while in the present disclosure, based on the global mode, troops in all virtual buildings can be viewed through the bubbles outside the virtual building, and the troops in the virtual building can be determined without the need to move to the corresponding virtual building.

In the present disclosure, FIG. 4 is a schematic diagram of a virtual object movement, according to one embodiment of the present disclosure. As shown in FIG. 4, when a player intends to transfer a troop in a virtual building A to a troop B, he/she may press and hold the troop attached on the virtual building A to drag. When a dragging distance is greater than a certain value, a connection line between a troop bubble and the virtual building is disconnected. When the troop is dragged to a certain range near a virtual building B, a virtual building dragging and placement region is highlighted and activated. When the troop bubble enters the region, it is automatically attached by the virtual building and a connection line is generated. At the same time, a confirmation pop-up window pops up. After confirm is clicked, a dynamic trajectory may appear between the troops A and B, and the troop bubble moves along the trajectory from the virtual building A to the virtual building B.

In some embodiments, a circle is drawn with the geometric center point of the virtual building as the center and R as the radius, and the region inside the circle is an attaching relationship determination region. If the center point of the bubble is within the determination region, it is determined to be attached; otherwise, it is determined to be detached.

In some embodiments, as shown in FIG. 4, the detachment and attaching processes have dynamic effects of the troop bubble and the connection line. Therefore, when it is determined to be detached, the troop bubble connection line may shrink from a city end to a bubble end and disappear. At the moment of attaching, the troop bubble connection line may grow from the bubble end to the city center end. At the same time, the bubble may have an appropriate displacement along a path of the connection line between the two centers.

It should be noted that as long as the global viewing mode is entered, troop mobilization may be performed on all own-side virtual buildings that can place troops. This operation is multi-directional and has nothing to do with the type of the virtual building.

In some embodiments, if a friend-side troop or an enemy attack troop enters the field of view and the target is an own-side virtual building, dynamic trajectories of the friend-side and enemy-side troops are displayed in the global mode.

In some embodiments, as shown in FIG. 4, in the global mode, the own-side troops and dynamic trajectories are always displayed, but the dynamic trajectories of the friend-side and enemy-side troops will only be displayed when their targets are within the field of view of own-side virtual buildings. At the same time, the dynamic trajectories of own-side, friend-side, and enemy-side troops may also be displayed in a big map game interface. In the global mode, the dynamic information of the troops is consistent and synchronized with the big map interface, but the information presentation is more comprehensive in the global mode, and the complete paths of the trajectories can be clearly seen, while in the big map, only the dynamic trajectory currently entering the picture can be seen.

In some embodiments, a global viewing mode is entered by long pressing any own-side virtual building on the big map in the global mode. In the global viewing mode, all own-side virtual buildings are displayed on the graphical user interface with the maximum display range. The player can click the return button to return to the big map interface, so that all own-side virtual buildings and their approximate distribution on the entire map can be viewed in one graphical user interface. By attaching the troops in the own-side virtual buildings in the form of “bubbles+lines” around the virtual buildings for display, the distribution of standby troops in various own-side virtual buildings may be overviewed in one graphical user interface, and by the appearance of the dynamic trajectories between the troops A and B, the complete marching paths of own-side troops on the entire map can be overviewed in one graphical user interface. By displaying the dynamic trajectories of friend-side and enemy-side troops, the complete marching paths of own-side troops on the entire map can be overviewed in one graphical user interface, and the marching path and approximate position of the enemy attack troops can be viewed from a wide range perspective, thereby realizing fast and efficient mobilization of troops between virtual buildings, and further solving the technical problem of low interaction efficiency of virtual building facilities in game scenes.

Based on the foregoing descriptions of the embodiments, those skilled in the art can clearly understand that the method according to the above embodiments may be implemented by software in addition to necessary hardware platform, and definitely, may also be implemented by hardware; however, in many situations, the former is a more preferable embodiment. Based on such an understanding, the technical solutions of the present disclosure essentially, or the part contributing to the related art, may be implemented in the form of a software product. The computer software product may be stored in a storage medium (such as a ROM/RAM, a magnetic disk, or an optical disc), and includes several instructions for enabling a terminal device (which may be a mobile phone, a computer, a server, a network device, or the like) to perform the methods in the embodiments of the present disclosure.

In this embodiment, a display control device for a virtual object is further provided. The device provides a graphical user interface, and display content of the graphical user interface includes a virtual scene and a plurality of virtual models located in the virtual scene. The device is used for implementing the above embodiments, and the details that have been explained will not be repeated here. As used below, the term “unit” refers to a combination of software and/or hardware that can implement a predetermined function. Although the devices described in the following embodiments are preferably implemented in software, implementation in hardware or a combination of software and hardware is also possible and conceivable.

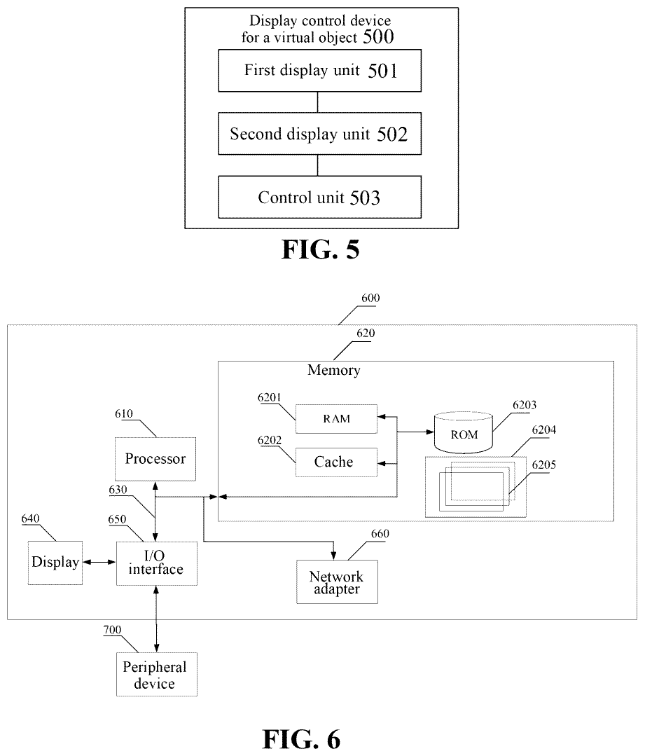

FIG. 5 is a block diagram of configuration of a display control device for a virtual object, according to one embodiment of the present disclosure. As shown in FIG. 5, the display control device 500 for a virtual object may include: a first display unit 501, a second display unit 502, and a control unit 503.

The first display unit 501 is used for displaying, in a graphical user interface, a first virtual scene picture corresponding to a first scale, where the first virtual scene picture includes at least one virtual model.

The second display unit 502 is used for displaying, in the graphical user interface, a target virtual scene picture corresponding to a target scale and an object control in response to a first operation of switching the first scale to the target scale, where the target virtual scene picture includes a virtual model set to which the virtual model belongs, and the object control is used for indicating a virtual controlled object associated with the virtual model in the virtual model set.

The control unit 503 is used for controlling, in response to a second operation on the object control, the virtual controlled object corresponding to the object control to move from a first virtual model to which the virtual controlled object belongs, to a second virtual model in the virtual model set.

In some embodiments, the first displaying unit is used to display, in the graphical user interface, the first virtual scene picture corresponding to the first scale, where the first virtual scene picture includes at least one virtual model. The second displaying unit is used to display, in the graphical user interface, the target virtual scene picture corresponding to the target scale and the object control in response to the first operation of switching the first scale to the target scale, where the target virtual scene picture includes the virtual model set to which the virtual model belongs, and the object control is used for indicating the virtual controlled object associated with the virtual model in the virtual model set. The controlling unit is used to control, in response to the second operation on the object control, the virtual controlled object corresponding to the object control to move from the first virtual model to which the virtual controlled object belongs, to the second virtual model in the virtual model set. In other words, the embodiment of the present disclosure displays, in the graphical user interface, the target virtual scene picture corresponding to the target scale and the object control, so that all virtual models and their distribution on the entire map can be overviewed on one screen, and scheduling of the virtual controlled object between different virtual models may be achieved by the object control, thereby improving the control efficiency of the virtual controlled object.

In some example embodiments of the present disclosure, the first operation is a selection operation on at least one virtual model, and the target scale is a second scale. The second display unit 502 is used for acquiring, in response to the selection operation on the at least one virtual model, the virtual model set to which the selected virtual model belongs; determining the second scale corresponding to the virtual model set, where the second scale enables the virtual model set to be completely displayed in the graphical user interface; and displaying, in the graphical user interface, a second virtual scene picture corresponding to the second scale and the object control, where the target virtual scene picture includes the second virtual scene picture.

Through the second display unit, when a player selects a virtual model, a scale displayed in the graphical user interface is automatically adjusted, so that a virtual model set to which the above virtual model belongs is completely displayed on the graphical user interface. This process not only simplifies the player's operation of adjusting the display scale of the virtual scene picture, but also makes it easier for the player to quickly determine another movable virtual model, thereby improving the control efficiency of the player over the virtual controlled object.

In some example embodiments of the present disclosure, the second display unit 502 is used for scaling down the virtual model set displayed at the first scale according to a preset scaling amplitude until all virtual models in the virtual model set are completely displayed in the graphical user interface; and determining a corresponding scale when all virtual models in the virtual model set are completely displayed in the graphical user interface as the second scale.

Through the second display unit, since the virtual scene picture at the first scale mainly displays picture content of the virtual model where the player controls a virtual character, when the player selects a virtual model, during displaying of the virtual model set to which the virtual model belongs, it is necessary to scale down the picture until all virtual models in the virtual model set are completely displayed on the graphical user interface. The process can quickly determine the optimal second scale to prevent the scaling magnitude from being too large to make it inconvenient for the player to perform a moving operation between virtual models, thereby improving the control efficiency of the player over the virtual controlled object.

In some example embodiments of the present disclosure, the first operation is a scaling operation on the first virtual scene picture, and the target scale is a third scale. The second display unit 502 is used for determining, in response to the scaling operation on the first virtual scene picture, the third scale corresponding to the scaling operation; determining virtual models existing in a third virtual scene picture at the third scale, and determining the virtual models existing in the third virtual scene picture as the virtual model set; determining a virtual controlled object associated with a virtual model in the virtual model set; and displaying, in the graphical user interface, the third virtual scene picture at the third scale and the object control corresponding to the virtual controlled object, where the target virtual scene picture includes the third virtual scene picture.

Through the second display unit, the player can manually scale down or up the display scale of the current virtual scene picture, so as to flexibly adjust the virtual models that can be accommodated in the current virtual scene picture, thereby improving the flexibility of the control operation of the player on the range of the displayed virtual models. At the same time, by determining the virtual controlled objects associated with various virtual models and the object controls corresponding to the virtual controlled objects, the control flexibility of the player over the virtual controlled objects is improved.

In some example embodiments of the present disclosure, the control unit 503 is used for performing the second operation on the object control, involving a dragging operation from the object control to a response region of the second virtual model, where the response region includes the second virtual model or a model peripheral region within a preset range of the second virtual model, or both.

Through the control unit, the player can drag the object control to the response region of the second virtual model. The dragging operation conforms to the player's operating habit of dragging an object to a target position, and greatly improves the viewing and mobilization efficiency of the user for his/her own-side virtual models and virtual controlled objects. Compared to the previous continuous switching, dragging the virtual controlled object from a global perspective improves the user's sense of manipulation and control over the situation. At the same time, when dragging from the object control to the second virtual model and/or the model peripheral region within the preset range of the second virtual model, the virtual controlled object may be triggered to move from the first virtual model to the second virtual model, which avoids the problem in the related art that the player needs to perform the dragging operation again if the object is not dragged to the second virtual model, resulting in low control efficiency of the virtual controlled object, thereby improving the control efficiency of the player over the virtual controlled object.

In some example embodiments of the present disclosure, the target virtual scene picture includes an object identifier corresponding to the virtual controlled object. The control unit 503 is used for generating, in the target virtual scene picture, a first trajectory route from the first virtual model to the second virtual model; and synchronously controlling, according to a moving progress of the virtual controlled object, the object identifier to move along the first trajectory route.

Through the control unit, the player can be assisted to slide based on the moving trajectory route according to the generated moving trajectory route, thereby providing operation assistance for the player. Moreover, the current moving progress of the virtual controlled object controlled by the player is displayed in real time, thereby improving the intuitiveness of the operation of the player.

In some example embodiments of the present disclosure, the target virtual scene picture includes a first relationship identifier corresponding to the virtual controlled object, and the first relationship identifier is used for indicating the belonging relationship between the virtual controlled object and the first virtual model. The display control device 500 for a virtual object may further include a third display unit, where the third display unit may be used for canceling, in response to a distance between the moved object identifier and the first virtual model being greater than a first distance threshold, display of the first relationship identifier in the target virtual scene picture; and displaying, in response to a distance between the moved object identifier and the second virtual model being less than a second distance threshold, a second relationship identifier in the target virtual scene picture, where the second relationship identifier is used for indicating the belonging relationship between the virtual controlled object and the second virtual model.

Through the identifier display unit, the player can be assisted to quickly acquire the belonging relationship between the virtual controlled object and the second virtual model based on the relationship identifier displayed in the virtual scene picture, thereby facilitating the player's understanding of the overall scene picture, and further improving the control of the player over the movements of various virtual controlled objects between various virtual models. At the same time, when the player controls the virtual controlled object to move from the first virtual model to the second virtual model, the relationship identifier is updated in time, thereby improving the timeliness of system information update.

In some example embodiments of the present disclosure, in response to the first operation of switching the first scale to the target scale, the second display unit 502 is used for controlling, in response to the first operation of switching the first scale to the target scale, scene elements in the virtual scene other than the virtual model set to perform a first size transformation according to the target scale, and controlling the virtual model set to perform a second size transformation according to a fourth scale, where the fourth scale is smaller than the target scale; and displaying the target virtual scene picture in the graphical user interface, where the target virtual scene picture includes the scene elements that have been subjected to the first size transformation according to the target scale, and the virtual model set that has been subjected to the second size transformation according to the fourth scale.

Through the second display unit, in response to the first operation of switching the first scale to the target scale, the scene elements in the virtual scene other than the virtual model set are controlled to be proportionally scaled to a first size according to the target scale to obtain a transformed graphical user interface. The scaled virtual scene picture may be displayed in the center of the graphical user interface, so that all virtual scene pictures can be overviewed in one graphical user interface. At the same time, a plurality of virtual models of different sizes are displayed in the same virtual scene picture, which not only highlights the model to prompt the user but also improves the richness of the virtual scene picture display.

In some example embodiments of the present disclosure, the display control device 500 for a virtual object may further include: an information determination unit, where the information determination unit is used for determining a target geometric region based on position information of each virtual model in the virtual model set in the virtual scene, where the target geometric region includes the position information of each virtual model in the virtual scene; and determining the target scale based on the side length of the target geometric region.

Through the information determination unit, the target geometric region is determined according to the position information of each virtual model in the virtual model set, and the target scale is determined based on the side length of the target geometric region, so that the first scale can be quickly switched to the target scale. At this time, the virtual scene picture can include every virtual model in the virtual model set, thereby improving the efficiency of the player in switching the virtual scene picture scale.

In some example embodiments of the present disclosure, the target geometric region is a rectangular region with the smallest area and including the position information of each virtual model in the virtual scene. The information determination unit is used for determining the longest side among a plurality of sides constituting the rectangular region, and determining a target side that matches the current resolution of the graphical user interface; and determining the target scale based on the longest side and the target side, where a ratio between the longest side after scaling the longest side according to the target scale and the target side meets a target ratio.

Through the information determination unit, when determining the target scale based on the side length of the target geometric region, the target side that matches the current resolution of the graphical user interface is selected from the plurality of sides. When the display ratio of the virtual scene picture is switched, the resolution of the scene picture is not affected, thereby avoiding the problem of resolution reduction and improving the gaming experience of the player.

In some example embodiments of the present disclosure, the third display unit is further used for displaying a second trajectory route of at least one friend-side virtual controlled object and/or at least one enemy-side virtual controlled object on the graphical user interface in response to a starting point of the movement of the at least one friend-side virtual controlled object and/or at least one enemy-side virtual controlled object of the virtual controlled object being in the target virtual scene picture, where the second trajectory route is used for indicating a complete path of the movement of the corresponding friend-side virtual controlled object and/or enemy-side virtual controlled object in the target virtual scene picture.

The third display unit, by displaying the dynamic trajectories of friend-side and enemy-side troops, can provide an overview of a complete marching path of own-side troops on the entire map in one graphical user interface; and can view the marching path and approximate position of the enemy attack troops in a wide range perspective, thereby realizing fast and efficient mobilization of troops between virtual buildings, and further solving the technical problem of low interaction efficiency of virtual building facilities in game scenes.

It should be noted that the above units may be implemented by software or hardware.

For the latter, it may be implemented in, but not limited to, the following ways: the above units are all located in the same processor; or the above units are located in different processors in any combination.

The embodiments of the present disclosure further provide a computer-readable storage medium storing a computer program, where the computer program is configured to perform, when running, the steps in any one of the above method embodiments.

In some embodiments, the computer-readable storage medium may be configured to store a computer program for performing the following steps:
S1: Display, in a graphical user interface, a first virtual scene picture corresponding to a first scale, where the first virtual scene picture includes at least one virtual model;
S2: Display, in the graphical user interface, a target virtual scene picture corresponding to a target scale and an object control in response to a first operation of switching the first scale to the target scale, where the target virtual scene picture includes a virtual model set to which the virtual model belongs, and the object control is used for indicating a virtual controlled object associated with the virtual model in the virtual model set; and
S3: Control, in response to a second operation on the object control, the virtual controlled object corresponding to the object control to move from a first virtual model to which the virtual controlled object belongs, to a second virtual model in the virtual model set.

In the above embodiments, the first virtual scene picture corresponding to the first scale is displayed in the graphical user interface; the target virtual scene picture corresponding to the target scale and the object control are displayed in the graphical user interface in response to the first operation of switching the first scale to the target scale; and the virtual controlled object corresponding to the object control is controlled, in response to the second operation on the object control, to move from the first virtual model to which the virtual controlled object belongs, to the second virtual model in the virtual model set. In other words, the embodiment of the present disclosure displays, in the graphical user interface, the target virtual scene picture corresponding to the target scale and the object control, so that all virtual models and their distribution on the entire map can be overviewed on one screen, and scheduling of the virtual controlled object between different virtual models may be achieved by the object control, thereby improving the control efficiency of the virtual controlled object.

In some example embodiments of the present disclosure, the first operation is a selection operation on at least one virtual model, and the target scale is a second scale. The virtual model set to which the selected virtual model belongs is acquired in response to the selection operation on the at least one virtual model; the second scale corresponding to the virtual model set is determined, where the second scale enables the virtual model set to be completely displayed in the graphical user interface; and a second virtual scene picture corresponding to the second scale and the object control are displayed in the graphical user interface, where the target virtual scene picture includes the second virtual scene picture.

Through the above embodiments, when a player selects a virtual model, a scale displayed in the graphical user interface is automatically adjusted, so that a virtual model set to which the above virtual model belongs is completely displayed on the graphical user interface. This process not only simplifies the player's operation of adjusting the display scale of the virtual scene picture, but also makes it easier for the player to quickly determine another movable virtual model, thereby improving the control efficiency of the player over the virtual controlled object.

In some example embodiments of the present disclosure, the second scale is determined by the following manner: scaling down the virtual model set displayed at the first scale according to a preset scaling amplitude until all virtual models in the virtual model set are completely displayed in the graphical user interface; and determining a corresponding scale when all virtual models in the virtual model set are completely displayed in the graphical user interface as the second scale.

Through the above embodiments, since the virtual scene picture at the first scale mainly displays picture content of the virtual model where the player controls a virtual character, when the player selects a virtual model, during displaying of the virtual model set to which the virtual model belongs, it is necessary to scale down the picture until all virtual models in the virtual model set are completely displayed on the graphical user interface. The process can quickly determine the optimal second scale to prevent the scaling magnitude from being too large to make it inconvenient for the player to perform a moving operation between virtual models, thereby improving the control efficiency of the player over the virtual controlled object.

In some example embodiments of the present disclosure, the first operation is a scaling operation on the first virtual scene picture, and the target scale is a third scale. The third scale corresponding to the scaling operation is determined in response to the scaling operation on the first virtual scene picture; virtual models existing in a third virtual scene picture at the third scale are determined, and the virtual models existing in the third virtual scene picture are determined as the virtual model set; a virtual controlled object associated with a virtual model in the virtual model set is determined; and the third virtual scene picture at the third scale and the object control corresponding to the virtual controlled object are displayed in the graphical user interface, where the target virtual scene picture includes the third virtual scene picture.

Through the above embodiments, the player can manually scale down or up the display scale of the current virtual scene picture, so as to flexibly adjust the virtual models that can be accommodated in the current virtual scene picture, thereby improving the flexibility of the control operation of the player on the range of the displayed virtual models. At the same time, by determining the virtual controlled objects associated with various virtual models and the object controls corresponding to the virtual controlled objects, the control flexibility of the player over the virtual controlled objects is improved.

In some example embodiments of the present disclosure, the second operation on the object control includes: a dragging operation from the object control to a response region of the second virtual model, where the response region includes at least one of the second virtual model or a model peripheral region within a preset range of the second virtual model.

Through the above embodiments, the player can drag the object control to the response region of the second virtual model. The dragging operation conforms to the player's operating habit of dragging an object to a target position, and greatly improves the viewing and mobilization efficiency of the user for his/her own-side virtual models and virtual controlled objects. Compared to the previous continuous switching, dragging the virtual controlled object from a global perspective improves the user's sense of manipulation and control over the situation. At the same time, when dragging from the object control to the second virtual model and/or the model peripheral region within the preset range of the second virtual model, the virtual controlled object may be triggered to move from the first virtual model to the second virtual model, which avoids the problem in the related art that the player needs to perform the dragging operation again if the object is not dragged to the second virtual model, resulting in low control efficiency of the virtual controlled object, thereby improving the control efficiency of the player over the virtual controlled object.

In some example embodiments of the present disclosure, the target virtual scene picture includes an object identifier corresponding to the virtual controlled object. The controlling the virtual controlled object corresponding to the object control to move from a first virtual model to which the virtual controlled object belongs, to a second virtual model in the virtual model set includes: generating, in the target virtual scene picture, a first trajectory route from the first virtual model to the second virtual model; and synchronously controlling, according to a moving progress of the virtual controlled object, the object identifier to move along the first trajectory route.

Through the above embodiments, the player may be assisted to slide based on the moving trajectory route according to the generated moving trajectory route, thereby providing operation assistance for the player. Moreover, the current moving progress of the virtual controlled object controlled by the player is displayed in real time, thereby improving the intuitiveness of the operation of the player.

In some example embodiments of the present disclosure, the target virtual scene picture includes a first relationship identifier corresponding to the virtual controlled object, and the first relationship identifier is used for indicating the belonging relationship between the virtual controlled object and the first virtual model. The method further includes: canceling, in response to a distance between the moved object identifier and the first virtual model being greater than a first distance threshold, display of the first relationship identifier in the target virtual scene picture; and displaying, in response to a distance between the moved object identifier and the second virtual model being less than a second distance threshold, a second relationship identifier in the target virtual scene picture, where the second relationship identifier is used for indicating the belonging relationship between the virtual controlled object and the second virtual model.

Through the above embodiments, the player can be assisted to quickly acquire the belonging relationship between the virtual controlled object and the second virtual model based on the relationship identifier displayed in the virtual scene picture, thereby facilitating the player's understanding of the overall scene picture, and further improving the control of the player over the movements of various virtual controlled objects between various virtual models. At the same time, when the player controls the virtual controlled object to move from the first virtual model to the second virtual model, the relationship identifier is updated in time, thereby improving the timeliness of system information update.

In some example embodiments of the present disclosure, the displaying, in the graphical user interface, a target virtual scene picture corresponding to a target scale in response to a first operation of switching the first scale to the target scale includes: controlling, in response to the first operation of switching the first scale to the target scale, scene elements in the virtual scene other than the virtual model set to perform a first size transformation according to the target scale, and controlling the virtual model set to perform a second size transformation according to a fourth scale, where the fourth scale is smaller than the target scale; and displaying the target virtual scene picture in the graphical user interface, where the target virtual scene picture includes the scene elements that have been subjected to the first size transformation according to the target scale, and the virtual model set that has been subjected to the second size transformation according to the fourth scale.

Through the above embodiments, in response to the first operation of switching the first scale to the target scale, the scene elements in the virtual scene other than the virtual model set are controlled to be proportionally scaled to a first size according to the target scale to obtain a transformed graphical user interface. The scaled virtual scene picture may be displayed in the center of the graphical user interface, so that all virtual scene pictures can be overviewed in one graphical user interface. At the same time, a plurality of virtual models of different sizes are displayed in the same virtual scene picture, which not only highlights the model to prompt the user but also improves the richness of the virtual scene picture display.

In some example embodiments of the present disclosure, a target geometric region is determined based on position information of each virtual model in the virtual model set in the virtual scene, where the target geometric region includes the position information of each virtual model in the virtual scene; and the target scale is determined based on the side length of the target geometric region.

Through the above embodiments, the target geometric region is determined according to the position information of each virtual model in the virtual model set, and the target scale is determined based on the side length of the target geometric region, so that the first scale can be quickly switched to the target scale. At this time, the virtual scene picture can include every virtual model in the virtual model set, thereby improving the efficiency of the player in switching the virtual scene picture scale.

In some example embodiments of the present disclosure, the target geometric region is a rectangular region with the smallest area and including the position information of each virtual model in the virtual scene. The determining the target scale based on the side length of the target geometric region includes: determining the longest side among a plurality of sides constituting the rectangular region, and determining a target side that matches the current resolution of the graphical user interface; and determining the target scale based on the longest side and the target side, where a ratio between the longest side after scaling the longest side according to the target scale and the target side meets a target ratio.

Through the above embodiments, when determining the target scale based on the side length of the target geometric region, the target side that matches the current resolution of the graphical user interface is selected from the plurality of sides. When the display ratio of the virtual scene picture is switched, the resolution of the scene picture is not affected, thereby avoiding the problem of resolution reduction and improving the gaming experience of the player.

In some example embodiments of the present disclosure, a second trajectory route of at least one friend-side virtual controlled object and/or at least one enemy-side virtual controlled object is displayed on the graphical user interface in response to a starting point of the movement of the at least one friend-side virtual controlled object and/or at least one enemy-side virtual controlled object of the virtual controlled object in the target virtual scene picture, where the second trajectory route is used for indicating a complete path of the movement of the corresponding friend-side virtual controlled object and/or enemy-side virtual controlled object in the target virtual scene picture.

Through the above embodiments, by displaying the dynamic trajectories of friend-side and enemy-side troops, can provide an overview of a complete marching path of own-side troops on the entire map in one graphical user interface; and can view the marching path and approximate position of the enemy attack troops in a wide range perspective, thereby realizing fast and efficient mobilization of troops between virtual buildings, and further solving the technical problem of low interaction efficiency of virtual building facilities in game scenes. In some embodiments, the above computer-readable storage medium may include but is not limited to: a USB flash drive, a Read-Only Memory (ROM), a Random Access Memory (RAM), a mobile hard disk, a magnetic disk, an optical disk, or other media that can store computer programs.

The embodiments of the present disclosure further provide an electronic device including a memory and a processor, where a computer program is stored in the memory, and the processor is configured to run the computer program to perform the steps in any one of the above method embodiments.

In some embodiments, the electronic device may further include a transmission device and an input/output device, where the transmission device is connected to the processor, and the input/output device is connected to the processor.

In some embodiments, the processor may be configured to perform the following steps through the computer program:
S1: Display, in a graphical user interface, a first virtual scene picture corresponding to a first scale, where the first virtual scene picture includes at least one virtual model;
S2: Display, in the graphical user interface, a target virtual scene picture corresponding to a target scale and an object control in response to a first operation of switching the first scale to the target scale, where the target virtual scene picture includes a virtual model set to which the virtual model belongs, and the object control is used for indicating a virtual controlled object associated with the virtual model in the virtual model set; and
S3: Control, in response to a second operation on the object control, the virtual controlled object corresponding to the object control to move from a first virtual model to which the virtual controlled object belongs, to a second virtual model in the virtual model set.

The first virtual scene picture corresponding to the first scale is displayed in the graphical user interface; the target virtual scene picture corresponding to the target scale and the object control are displayed in the graphical user interface in response to the first operation of switching the first scale to the target scale; and the virtual controlled object corresponding to the object control is controlled, in response to the second operation on the object control, to move from the first virtual model to which the virtual controlled object belongs, to the second virtual model in the virtual model set. In other words, the embodiment of the present disclosure displays, in the graphical user interface, the target virtual scene picture corresponding to the target scale and the object control, so that all virtual models and their distribution on the entire map can be overviewed on one screen, and scheduling of the virtual controlled object between different virtual models may be achieved by the object control, thereby improving the control efficiency of the virtual controlled object.

In some example embodiments of the present disclosure, the first operation is a selection operation on at least one virtual model, and the target scale is a second scale. The displaying, in the graphical user interface, a target virtual scene picture corresponding to a target scale and an object control in response to a first operation of switching the first scale to the target scale includes: acquiring, in response to the selection operation on the at least one virtual model, the virtual model set to which the selected virtual model belongs; determining the second scale corresponding to the virtual model set, where the second scale enables the virtual model set to be completely displayed in the graphical user interface; and displaying, in the graphical user interface, a second virtual scene picture corresponding to the second scale and the object control, where the target virtual scene picture includes the second virtual scene picture.

Through the above embodiments, when a player selects a virtual model, a scale displayed in the graphical user interface is automatically adjusted, so that a virtual model set to which the above virtual model belongs is completely displayed on the graphical user interface. This process not only simplifies the player's operation of adjusting the display scale of the virtual scene picture, but also makes it easier for the player to quickly determine another movable virtual model, thereby improving the control efficiency of the player over the virtual controlled object.

In some example embodiments of the present disclosure, the second scale is determined by the following manner: scaling down the virtual model set displayed at the first scale according to a preset scaling amplitude until all virtual models in the virtual model set are completely displayed in the graphical user interface; and determining a corresponding scale when all virtual models in the virtual model set are completely displayed in the graphical user interface as the second scale.

Through the above embodiments, since the virtual scene picture at the first scale mainly displays picture content of the virtual model where the player controls a virtual character, when the player selects a virtual model, during displaying of the virtual model set to which the virtual model belongs, it is necessary to scale down the picture until all virtual models in the virtual model set are completely displayed on the graphical user interface. The process can quickly determine the optimal second scale to prevent the scaling magnitude from being too large to make it inconvenient for the player to perform a moving operation between virtual models, thereby improving the control efficiency of the player over the virtual controlled object.

In some example embodiments of the present disclosure, the first operation is a scaling operation on the first virtual scene picture, and the target scale is a third scale. The displaying, in the graphical user interface, a target virtual scene picture corresponding to a target scale and an object control in response to a first operation of switching the first scale to the target scale includes: determining, in response to the scaling operation on the first virtual scene picture, the third scale corresponding to the scaling operation; determining virtual models existing in a third virtual scene picture at the third scale, and determining the virtual models existing in the third virtual scene picture as the virtual model set; determining a virtual controlled object associated with a virtual model in the virtual model set; and displaying, in the graphical user interface, the third virtual scene picture at the third scale and the object control corresponding to the virtual controlled object, where the target virtual scene picture includes the third virtual scene picture.

Through the above embodiments, the player can manually scale down or up the display scale of the current virtual scene picture, so as to flexibly adjust the virtual models that can be accommodated in the current virtual scene picture, thereby improving the flexibility of the control operation of the player on the range of the displayed virtual models. At the same time, by determining the virtual controlled objects associated with various virtual models and the object controls corresponding to the virtual controlled objects, the control flexibility of the player over the virtual controlled objects is improved.

In some example embodiments of the present disclosure, the second operation on the object control includes: a dragging operation from the object control to a response region of the second virtual model, where the response region includes at least one of the second virtual model or a model peripheral region within a preset range of the second virtual model.

Through the above embodiments, the player can drag the object control to the response region of the second virtual model. The dragging operation conforms to the player's operating habit of dragging an object to a target position, and greatly improves the viewing and mobilization efficiency of the user for his/her own-side virtual models and virtual controlled objects. Compared to the previous continuous switching, dragging the virtual controlled object from a global perspective improves the user's sense of manipulation and control over the situation. At the same time, when dragging from the object control to the second virtual model and/or the model peripheral region within the preset range of the second virtual model, the virtual controlled object may be triggered to move from the first virtual model to the second virtual model, which avoids the problem in the related art that the player needs to perform the dragging operation again if the object is not dragged to the second virtual model, resulting in low control efficiency of the virtual controlled object, thereby improving the control efficiency of the player over the virtual controlled object.

In some example embodiments of the present disclosure, the target virtual scene picture includes an object identifier corresponding to the virtual controlled object. The controlling the virtual controlled object corresponding to the object control to move from a first virtual model to which the virtual controlled object belongs, to a second virtual model in the virtual model set includes: generating, in the target virtual scene picture, a first trajectory route from the first virtual model to the second virtual model; and synchronously controlling, according to a moving progress of the virtual controlled object, the object identifier to move along the first trajectory route.

Through the above embodiments, the player may be assisted to slide based on the moving trajectory route according to the generated moving trajectory route, thereby providing operation assistance for the player. Moreover, the current moving progress of the virtual controlled object controlled by the player is displayed in real time, thereby improving the intuitiveness of the operation of the player.

In some example embodiments of the present disclosure, the target virtual scene picture includes a first relationship identifier corresponding to the virtual controlled object, and the first relationship identifier is used for indicating the belonging relationship between the virtual controlled object and the first virtual model. The method further includes: canceling, in response to a distance between the moved object identifier and the first virtual model being greater than a first distance threshold, display of the first relationship identifier in the target virtual scene picture; and displaying, in response to a distance between the moved object identifier and the second virtual model being less than a second distance threshold, a second relationship identifier in the target virtual scene picture, where the second relationship identifier is used for indicating the belonging relationship between the virtual controlled object and the second virtual model.

Through the above embodiments, the player can be assisted to quickly acquire the belonging relationship between the virtual controlled object and the second virtual model based on the relationship identifier displayed in the virtual scene picture, thereby facilitating the player's understanding of the overall scene picture, and further improving the control of the player over the movements of various virtual controlled objects between various virtual models. At the same time, when the player controls the virtual controlled object to move from the first virtual model to the second virtual model, the relationship identifier is updated in time, thereby improving the timeliness of system information update.

In some example embodiments of the present disclosure, the displaying, in the graphical user interface, a target virtual scene picture corresponding to a target scale in response to a first operation of switching the first scale to the target scale includes: controlling, in response to the first operation of switching the first scale to the target scale, scene elements in the virtual scene other than the virtual model set to perform a first size transformation according to the target scale, and controlling the virtual model set to perform a second size transformation according to a fourth scale, where the fourth scale is smaller than the target scale; and displaying the target virtual scene picture in the graphical user interface, where the target virtual scene picture includes the scene elements that have been subjected to the first size transformation according to the target scale, and the virtual model set that has been subjected to the second size transformation according to the fourth scale.

Through the above embodiments, in response to the first operation of switching the first scale to the target scale, the scene elements in the virtual scene other than the virtual model set are controlled to be proportionally scaled to a first size according to the target scale to obtain a transformed graphical user interface. The scaled virtual scene picture may be displayed in the center of the graphical user interface, so that all virtual scene pictures can be overviewed in one graphical user interface. At the same time, a plurality of virtual models of different sizes are displayed in the same virtual scene picture, which not only highlights the model to prompt the user but also improves the richness of the virtual scene picture display.

In some example embodiments of the present disclosure, a target geometric region is determined based on position information of each virtual model in the virtual model set in the virtual scene, where the target geometric region includes the position information of each virtual model in the virtual scene; and the target scale is determined based on the side length of the target geometric region.

Through the above embodiments, the target geometric region is determined according to the position information of each virtual model in the virtual model set, and the target scale is determined based on the side length of the target geometric region, so that the first scale can be quickly switched to the target scale. At this time, the virtual scene picture can include every virtual model in the virtual model set, thereby improving the efficiency of the player in switching the virtual scene picture scale.

In some example embodiments of the present disclosure, the target geometric region is a rectangular region with the smallest area and including the position information of each virtual model in the virtual scene. The determining the target scale based on the side length of the target geometric region includes: determining the longest side among a plurality of sides constituting the rectangular region, and determining a target side that matches the current resolution of the graphical user interface; and determining the target scale based on the longest side and the target side, where a ratio between the longest side after scaling the longest side according to the target scale and the target side meets a target ratio.

Through the above embodiments, when determining the target scale based on the side length of the target geometric region, the target side that matches the current resolution of the graphical user interface is selected from the plurality of sides. When the display ratio of the virtual scene picture is switched, the resolution of the scene picture is not affected, thereby avoiding the problem of resolution reduction and improving the gaming experience of the player.

In some example embodiments of the present disclosure, a second trajectory route of at least one friend-side virtual controlled object and/or at least one enemy-side virtual controlled object is displayed on the graphical user interface in response to a starting point of the movement of the at least one friend-side virtual controlled object and/or at least one enemy-side virtual controlled object of the virtual controlled object in the target virtual scene picture, where the second trajectory route is used for indicating a complete path of the movement of the corresponding friend-side virtual controlled object and/or enemy-side virtual controlled object in the target virtual scene picture.

Through the above embodiments, by displaying the dynamic trajectories of friend-side and enemy-side troops, can provide an overview of a complete marching path of own-side troops on the entire map in one graphical user interface; and can view the marching path and approximate position of the enemy attack troops in a wide range perspective, thereby realizing fast and efficient mobilization of troops between virtual buildings, and further solving the technical problem of low interaction efficiency of virtual building facilities in game scenes.

The specific examples in this embodiment may be obtained with reference to the examples described in the above embodiments, and this embodiment will not be described in detail here.

FIG. 6 is a schematic diagram of an electronic device, according to one embodiment of the present disclosure. As shown in FIG. 6, the electronic device 600 is merely an example and should not bring any limitation to the functions and scope of use of the embodiments of the present disclosure.

As shown in FIG. 6, the electronic device 600 is represented in the form of a general-purpose computing device. The components of the electronic device 600 may include, but are not limited to: the at least one processor 610, the at least one memory 620, a bus 630 connecting different system components (including the memory 620 and the processor 610), and a display 640.

The memory 620 stores program codes, and the program codes may be executed by the processor 610 so that the processor 610 performs the steps according to various example embodiments of the present disclosure described in the method part of the embodiments of the present disclosure.

The memory 620 may include a readable medium in the form of a volatile storage unit, such as a random access memory unit (RAM) 6201 and/or a cache memory unit 6202, and may further include a read-only memory unit (ROM) 6203, and may also include a non-volatile memory, such as one or a plurality of magnetic storage devices, flash memories, or other non-volatile solid-state memories.

In some instances, the memory 620 may also include a program/utility 6204 having a set (at least one) of program modules 6205, such program modules 6205 including but not limited to: an operating system, one or a plurality of application programs, other program modules, and program data, each of the examples or a combination thereof may include an implementation of a network environment. The memory 620 may further include memories remotely located relative to the processor 610, and these remote memories may be connected to the electronic device 600 via a network. Examples of the above network include, but are not limited to, the Internet, an intranet, a local area network, a mobile communication network, and a combination thereof.

The bus 630 may represent one or a plurality of several types of bus configurations, including a memory unit bus or a memory unit controller, a peripheral bus, an accelerated graphics port, the processor 610, or a local bus using any bus configuration of a variety of bus configurations.

The display 640 may be, for example, a touch screen liquid crystal display (LCD), and the liquid crystal display enables a user to interact with a user interface of the electronic device 600.

In some embodiments, the electronic device 600 may also communicate with one or a plurality of external devices 700 (such as a keyboard, a pointing device, and a Bluetooth device), with one or a plurality of devices that enable a user to interact with the electronic device 600, and/or with any device (such as a router and a modem) that enables the electronic device 600 to communicate with one or a plurality of other computing devices. Such communications may be performed through an input/output (I/O) interface 650. Furthermore, the electronic device 600 may also communicate with one or a plurality of networks (for example, a local area network (LAN), a wide area network (WAN), and/or a public network, such as the Internet) through a network adapter 660. As shown in FIG. 6, the network adapter 660 communicates with other modules of the electronic device 600 through the bus 630. It should be understood that although not shown in FIG. 6, other hardware and/or software modules may be used in conjunction with the electronic device 600, including but not limited to: microcodes, device drivers, redundant processing units, external disk drive arrays, RAID systems, tape drives, data backup storage systems, and the like.

The electronic device 600 may further include: a keyboard, a cursor control device (such as a mouse), an input/output interface (I/O interface), a network interface, a power supply and/or a camera.

Those of ordinary skill in the art can understand that the configuration shown in FIG. 6 is merely schematic, and is not intended to limit the configuration of the above electronic device.

For example, the electronic device 600 may further include more or fewer components than those shown in FIG. 6, or have a configuration different from that shown in FIG. 1. The memory 620 may be used for storing computer programs and corresponding data, such as the computer program and corresponding data corresponding to the display control method for a virtual object, as depicted in the embodiments of the present disclosure. The processor 610 performs various functional applications and data processing by implementing the above display control method through the computer program stored in the memory 620.

The serial numbers of the embodiments of the present disclosure are merely used for description, and do not imply the preference among the embodiments.

In the above embodiments of the present disclosure, the descriptions of the embodiments have different emphases, and for parts that are not described in detail in an embodiment, reference may be made to related descriptions in other embodiments.

In the embodiments provided in the present disclosure, it should be understood that, the disclosed technical content may be implemented in other manners. For example, the device embodiment described in the foregoing may be schematic, for example, the division of units is merely division of logic functions, and in fact, there may be other division manners during actual implementation. For example, a plurality of units or components may be combined or may be integrated into another system, or some features may be ignored or not be performed.

On the other hand, the shown or discussed coupling or direct coupling or communication connection between them may be implemented by using some interfaces, and indirect coupling or communication connection between units or modules may be in an electrical form or other forms.

Units described as separated parts may be or may not be physically separated, parts shown as units may be or may not be physical units, and they may be located at the same place, or be distributed to a plurality of network units. The objective of the solution of this embodiment may be implemented by selecting a part of or all units therein according to actual requirements.

In addition, various functional units in the embodiments of the present disclosure may be integrated into one processing unit, each unit may also exist alone physically, and two or more units may also be integrated into one unit. The integrated unit may be implemented in the form of hardware, and may also be implemented in the form of a software functional unit.

The integrated unit, if implemented in the form of a software functional unit and sold or used as an independent product, may be stored in a computer-readable storage medium. Based on such an understanding, the technical solutions of the present disclosure essentially, or the part contributing to the related art, or all or a part of the technical solution may be implemented in the form of a software product. The computer software product may be stored in a storage medium, and includes several instructions for instructing a computer device (which may be a personal computer, a server, a network device or the like) to perform all or a part of the steps in the methods described in the embodiments of the present disclosure. The storage medium includes: a USB flash disk, a Read-Only Memory (ROM), a Random Access Memory (RAM), a mobile hard disk, a magnetic disk, an optical disc, or other mediums that can store program codes.

Those described above are merely preferred embodiments of the present disclosure. It should be noted that, those of ordinary skill in the art may further obtain several variations and improvements without departing from the principle of the present disclosure, and the variations and improvements all fall within the protection scope of the present disclosure.

1. A display control method for a virtual object, comprising:
displaying, in a graphical user interface provided by a terminal device, a first virtual scene picture corresponding to a first scale, wherein the first virtual scene picture comprises a virtual model, and the virtual model is located in a virtual scene displayed by the graphical user interface;
displaying, in the graphical user interface, a target virtual scene picture corresponding to a target scale and an object control in response to a first operation of switching the first scale to the target scale, wherein the target virtual scene picture comprises a virtual model set, the virtual model set comprises the virtual model, and the object control is configured for indicating a virtual controlled object associated with the virtual model in the virtual model set; and
controlling, in response to a second operation on the object control, the virtual controlled object corresponding to the object control to move from a first virtual model that comprises the virtual controlled object, to a second virtual model in the virtual model set.

2. The method according to claim 1, wherein the first operation is a selection operation on the virtual model, and the target scale is a second scale, and
wherein displaying, in the graphical user interface, the target virtual scene picture corresponding to the target scale and the object control in response to the first operation of switching the first scale to the target scale comprises:
acquiring, in response to the selection operation on the virtual model, the virtual model set that comprises the virtual model;
determining the second scale corresponding to the virtual model set, wherein the second scale enables the virtual model set to be completely displayed in the graphical user interface; and
displaying, in the graphical user interface, a second virtual scene picture corresponding to the second scale and the object control, wherein the target virtual scene picture comprises the second virtual scene picture.

3. The method according to claim 2, wherein determining the second scale corresponding to the virtual model set comprise:
scaling down, according to a preset scaling amplitude, the virtual model set displayed at the first scale until all virtual models in the virtual model set are completely displayed in the graphical user interface; and
determining the corresponding scale when all virtual models in the virtual model set are completely displayed on the graphical user interface as the second scale.

4. The method according to claim 1, wherein the first operation is a scaling operation on the first virtual scene picture, and the target scale is a third scale, and
wherein displaying, in the graphical user interface, the target virtual scene picture corresponding to the target scale and the object control in response to the first operation of switching the first scale to the target scale comprises:
determining, in response to the scaling operation on the first virtual scene picture, the third scale corresponding to the scaling operation;
determining one or more virtual models existing in a third virtual scene picture at the third scale, and determining the one or more virtual models existing in the third virtual scene picture as the virtual model set;
determining the virtual controlled object associated with the virtual model in the virtual model set; and
displaying, in the graphical user interface, the third virtual scene picture at the third scale and the object control corresponding to the virtual controlled object, wherein the target virtual scene picture comprises the third virtual scene picture.

5. The method according to claim 1, wherein the second operation on the object control comprises a dragging operation from the object control to a response region of the second virtual model, wherein the response region comprises at least one of the second virtual model or a model peripheral region within a preset range of the second virtual model.

6. The method according to claim 1, wherein the target virtual scene picture comprises an object identifier corresponding to the virtual controlled object, and
wherein controlling the virtual controlled object corresponding to the object control to move from the first virtual model that comprises the virtual controlled object, to the second virtual model in the virtual model set comprises:
generating, in the target virtual scene picture, a first trajectory route from the first virtual model to the second virtual model; and
synchronously controlling, according to a moving progress of the virtual controlled object, the object identifier to move along the first trajectory route.

7. The method according to claim 6, wherein the target virtual scene picture comprises a first relationship identifier corresponding to the virtual controlled object, and the first relationship identifier is configured for indicating a belonging relationship between the virtual controlled object and the first virtual model, and wherein the method further comprises:
canceling, in response to a distance between the moved object identifier and the first virtual model being greater than a first distance threshold, display of the first relationship identifier in the target virtual scene picture; and
displaying, in response to a distance between the moved object identifier and the second virtual model being less than a second distance threshold, a second relationship identifier in the target virtual scene picture, wherein the second relationship identifier is configured for indicating a belonging relationship between the virtual controlled object and the second virtual model.

8. The method according to claim 1, wherein displaying, in the graphical user interface, the target virtual scene picture corresponding to the target scale in response to the first operation of switching the first scale to the target scale comprises:
controlling, in response to the first operation of switching the first scale to the target scale, one or more scene elements in the virtual scene other than the virtual model set to perform a first size transformation according to the target scale, and controlling the virtual model set to perform a second size transformation according to a fourth scale, wherein the fourth scale is smaller than the target scale; and
displaying the target virtual scene picture in the graphical user interface, wherein the target virtual scene picture comprises the one or more scene elements that have been subjected to the first size transformation according to the target scale, and the virtual model set that has been subjected to the second size transformation according to the fourth scale.

9. The method according to claim 8, wherein displaying, in the graphical user interface, the target virtual scene picture corresponding to the target scale in response to the first operation of switching the first scale to the target scale further comprises:
determining a target geometric region based on position information of each virtual model in the virtual model set in the virtual scene, wherein the target geometric region comprises the position information of each virtual model in the virtual scene; and
determining the target scale based on a side length of the target geometric region.

10. The method according to claim 9, wherein the target geometric region is a rectangular region with the smallest area that comprises the position information of each virtual model in the virtual scene, and
wherein determining the target scale based on the side length of the target geometric region comprises:
determining the longest side among a plurality of sides constituting the rectangular region, and determining a target side that matches a current resolution of the graphical user interface; and
determining the target scale based on the longest side and the target side, wherein a ratio between the longest side after scaling the longest side according to the target scale and the target side meets a target ratio.

11. The method according to claim 1, wherein the method further comprises:
displaying, in response to a starting point of movement of at least one of a friend-side virtual controlled object or an enemy-side virtual controlled object of the virtual controlled object in the target virtual scene picture, a second trajectory route of the at least one of the friend-side virtual controlled object or an enemy-side virtual controlled object on the graphical user interface, wherein the second trajectory route is configured for indicating a complete movement path of the corresponding friend-side virtual controlled object or the enemy-side virtual controlled object in the target virtual scene picture.

12. (canceled)

13. One or more non-transitory computer-readable storage media containing, in any combination, computer program code that, when executed by a computer system, perform an operation comprising:
displaying, in a graphical user interface provided by a terminal device, a first virtual scene picture corresponding to a first scale, wherein the first virtual scene picture comprises a virtual model, and the virtual model is located in a virtual scene displayed by the graphical user interface;
displaying, in the graphical user interface, a target virtual scene picture corresponding to a target scale and an object control in response to a first operation of switching the first scale to the target scale, wherein the target virtual scene picture comprises a virtual model set, the virtual model set comprises the virtual model, and the object control is configured for indicating a virtual controlled object associated with the virtual model in the virtual model set; and
controlling, in response to a second operation on the object control, the virtual controlled object corresponding to the object control to move from a first virtual model that comprises the virtual controlled object, to a second virtual model in the virtual model set.

14. A system, comprising:
one or more memories collectively containing one or more programs; and
one or more processors, wherein the one or more processors are configured to, individually or collectively, perform an operation comprising:
displaying, in a graphical user interface provided by a terminal device, a first virtual scene picture corresponding to a first scale, wherein the first virtual scene picture comprises a virtual model, and the virtual model is located in a virtual scene displayed by the graphical user interface;
displaying, in the graphical user interface, a target virtual scene picture corresponding to a target scale and an object control in response to a first operation of switching the first scale to the target scale, wherein the target virtual scene picture comprises a virtual model set, the virtual model set comprises the virtual model, and the object control is configured for indicating a virtual controlled object associated with the virtual model in the virtual model set; and
controlling, in response to a second operation on the object control, the virtual controlled object corresponding to the object control to move from a first virtual model that comprises the virtual controlled object, to a second virtual model in the virtual model set.

15. The system according to claim 14, wherein the first operation is a selection operation on the virtual model, and the target scale is a second scale, and
wherein displaying, in the graphical user interface, the target virtual scene picture corresponding to the target scale and the object control in response to the first operation of switching the first scale to the target scale comprises:
acquiring, in response to the selection operation on the virtual model, the virtual model set that comprises the virtual model;
determining the second scale corresponding to the virtual model set, wherein the second scale enables the virtual model set to be completely displayed in the graphical user interface; and
displaying, in the graphical user interface, a second virtual scene picture corresponding to the second scale and the object control, wherein the target virtual scene picture comprises the second virtual scene picture.

16. The system according to claim 15, wherein determining the second scale corresponding to the virtual model set comprise:
scaling down, according to a preset scaling amplitude, the virtual model set displayed at the first scale until all virtual models in the virtual model set are completely displayed in the graphical user interface; and
determining the corresponding scale when all virtual models in the virtual model set are completely displayed on the graphical user interface as the second scale.

17. The system according to claim 14, wherein the first operation is a scaling operation on the first virtual scene picture, and the target scale is a third scale, and
wherein displaying, in the graphical user interface, the target virtual scene picture corresponding to the target scale and the object control in response to the first operation of switching the first scale to the target scale comprises:
determining, in response to the scaling operation on the first virtual scene picture, the third scale corresponding to the scaling operation;
determining one or more virtual models existing in a third virtual scene picture at the third scale, and determining the one or more virtual models existing in the third virtual scene picture as the virtual model set;
determining the virtual controlled object associated with the virtual model in the virtual model set; and
displaying, in the graphical user interface, the third virtual scene picture at the third scale and the object control corresponding to the virtual controlled object, wherein the target virtual scene picture comprises the third virtual scene picture.

18. The system according to claim 14, wherein the second operation on the object control comprises a dragging operation from the object control to a response region of the second virtual model, wherein the response region comprises at least one of the second virtual model or a model peripheral region within a preset range of the second virtual model.

19. The system according to claim 14, wherein the target virtual scene picture comprises an object identifier corresponding to the virtual controlled object, and
wherein controlling the virtual controlled object corresponding to the object control to move from the first virtual model that comprises the virtual controlled object, to the second virtual model in the virtual model set comprises:
generating, in the target virtual scene picture, a first trajectory route from the first virtual model to the second virtual model; and
synchronously controlling, according to a moving progress of the virtual controlled object, the object identifier to move along the first trajectory route.

20. The system according to claim 14, wherein displaying, in the graphical user interface, the target virtual scene picture corresponding to the target scale in response to the first operation of switching the first scale to the target scale comprises:
controlling, in response to the first operation of switching the first scale to the target scale, one or more scene elements in the virtual scene other than the virtual model set to perform a first size transformation according to the target scale, and controlling the virtual model set to perform a second size transformation according to a fourth scale, wherein the fourth scale is smaller than the target scale; and
displaying the target virtual scene picture in the graphical user interface, wherein the target virtual scene picture comprises the one or more scene elements that have been subjected to the first size transformation according to the target scale, and the virtual model set that has been subjected to the second size transformation according to the fourth scale.

21. The system according to claim 14, wherein the operation further comprises:
displaying, in response to a starting point of movement of at least one of a friend-side virtual controlled object or an enemy-side virtual controlled object of the virtual controlled object in the target virtual scene picture, a second trajectory route of the at least one of the friend-side virtual controlled object or an enemy-side virtual controlled object on the graphical user interface, wherein the second trajectory route is configured for indicating a complete movement path of the corresponding friend-side virtual controlled object or the enemy-side virtual controlled object in the target virtual scene picture.
